(19) United States
(12) Patent Application Publication
(10) Pub. No.: US 2017/0129234 A1
(43) Pub. Date: May 11, 2017

(54) Apparatus for Thermal Processing of Flexographic Printing Elements

(71) Applicant: MacDermid Printing Solutions, LLC, Waterbury, CT (US)

(72) Inventors: Ryan W. Vest, Cumming, GA (US); Gary T. Markhart, Carlsbad, CA (US); Brian Cook, Roswell, GA (US)

(21) Appl. No.: 14/937,267

(22) Filed: Nov. 10, 2015

(51) Int. Cl. B41C 1/00

(52) U.S. Cl. CPC B41C 1/006

(57) ABSTRACT

An apparatus for thermally processing a relief image printing element and a method of using the same. The relief image printing element comprises at least one photopolymer layer, and is selectively exposed to actinic radiation to crosslink portions of the at least one photopolymer layer, while portions of the at least one photopolymer layer are not exposed to actinic radiation, and are not crosslinked. The apparatus comprises: a) a means for supporting the relief image printing element; b) heating means for melting or softening non-crosslinked portions of the at least one photopolymer layer; c) at least one rotatable roll that is capable of bringing a blotting material into contact with the at least one photopolymer layer to remove the melted or softened non-crosslinked portions of the at least one photopolymer layer; and d) a rotatable cleaning roll arranged adjacent to the at least one rotatable roll, for removing non-crosslinked photopolymer remaining on a surface of the at least one rotatable roll after step c).

### FIELD OF THE INVENTION

The present invention relates generally to an apparatus for thermal processing of flexographic printing elements and a method of using the same.

### BACKGROUND OF THE INVENTION

Flexography is a method of printing that is commonly used for high-volume runs. Flexography is employed for printing on a variety of substrates such as paper, paperboard stock, corrugated board, films, foils and laminates. Newspapers and grocery bags are prominent examples. Coarse surfaces and stretched films can be economically printed only by means of flexography.

Flexographic printing plates are relief plates with image elements raised above open areas. Such plates offer a number of advantages to the printer, based chiefly on their durability and the ease with which they can be made. A typical flexographic printing blank as delivered by its manufacturer, is a multilayered article made of, in order, a backing or support layer, one or more layers of unexposed (uncured) photopolymer, a protective layer or slip film, and a cover sheet.

The one or more unexposed photopolymer layer(s) can include any of the known photopolymers, monomers, initiators, reactive or non-reactive diluents, fillers, and dyes. The term “photocurable” refers to a composition which undergoes polymerization, cross-linking, or any other curing or hardening reaction in response to actinic radiation with the result that the unexposed portions of the material can be selectively separated and removed from the exposed (cured) portions to form a three-dimensional or relief pattern of cured material. Preferred photocurable materials include an elastomeric compound, an ethylenically unsaturated compound having at least one terminal ethylene group, and a photoinitiator. Exemplary photocurable materials are disclosed in European Patent Application Nos. 0 456 336 A2 and 0 640 878 A1 to Goss, et al., British Patent No. 1,366,769, U.S. Pat. No. 5,223,375 to Berrier, et al., U.S. Pat. No. 3,867,153 to MacLahan, U.S. Pat. No. 4,264,705 to Allen, U.S. Pat. Nos. 4,323,636, 4,323,637, 4,369,246, and 4,423,135 all to Chen, et al., U.S. Pat. No. 3,265,765 to Holden, et al., U.S. Pat. No. 4,320,188 to Heinz, et al., U.S. Pat. No. 4,427,759 to Gruetzmacher, et al., U.S. Pat. No. 4,622,088 to Min, and U.S. Pat. No. 5,135,827 to Bohm, et al., the subject matter of each of which is herein incorporated by reference in its entirety. If a second photocurable layer is used, i.e., an overcoat layer, it typically is disposed upon the first layer and is similar in composition.

The photopolymer materials generally cross-link (cure) and harden in at least some actinic wavelength region. As used herein, actinic radiation is radiation capable of effecting a chemical change in an exposed moiety. Actinic radiation includes, for example, amplified (e.g., laser) and non-amplified light, particularly in the UV and infrared wavelength regions. Preferred actinic wavelength regions are from about 250 nm to about 450 nm, more preferably from about 300 nm to about 400 nm.

Although photopolymer printing elements are typically used in “flat” sheet form, there are particular applications and advantages to using the printing element in a continuous cylindrical form, as a “continuous in-the-round” (CITR) photopolymer sleeve. CITR sleeves have applications in the printing of continuous designs such as in wallpaper, decoration and gift-wrapping paper. A typical CITR photopolymer sleeve generally comprises a sleeve carrier (support layer) and at least one unexposed photocurable layer on top of the support layer.

A flexographic printing element is produced from a photopolymer printing blank by imaging the photopolymer printing blank to produce a relief image on the surface of the printing element. This is generally accomplished by selectively exposing the photocurable material to actinic radiation, which exposure acts to harden or crosslink the photocurable material in the irradiated areas. The areas that are not exposed to actinic radiation can then be removed in a subsequent step.

The printing element is selectively exposed to actinic radiation in one of several related ways. In a first alternative, a photographic negative with transparent areas and substantially opaque areas is used to selectively block the transmission of actinic radiation to the printing plate element. In a second alternative, the unexposed photopolymer layer is coated with an actinic radiation (substantially) opaque layer that is sensitive to laser ablation. A laser is then used to ablate selected areas of the actinic radiation opaque layer creating an in situ negative. This technique is well-known in the art, and is described for example in U.S. Pat. Nos. 5,262,275 and 6,238,837 to Fan, and in U.S. Pat. No. 5,925,500 to Yang et al., the subject matter of each of which is herein incorporated by reference in their entirety. In a third alternative, a focused beam of actinic radiation is used to selectively expose the photopolymer. Any of these alternative methods is acceptable, with the criteria being the ability to selectively expose the photopolymer to actinic radiation thereby selectively curing portions of the photopolymer.

Any conventional sources of actinic radiation can be used for the exposure step. Suitable visible or UV sources include carbon arcs, mercury-vapor arcs, fluorescent lamps, electron flash units, electron beam units and photographic flood lamps, by way of example and not limitation.

After imaging, the photosensitive printing element is processed or “developed” to remove uncured (i.e., non-crosslinked) portions of the photopolymer layer, without disturbing the cured portions of the photopolymer layer, to produce the relief image on the surface of the printing element. Typical methods of development include washing with various solvents or water, often with a brush. Other possibilities for development include thermal development or the use of an air knife.

It is highly desirable in the flexographic prepress printing industry to eliminate the need for chemical processing of printing elements in developing relief images, in order to go from plate to press more quickly. Thus, processes have been developed whereby photopolymer printing plates are prepared using heat and the differential melting temperature between cured and uncured photopolymer is used to develop the latent image. The basic parameters of this process are known, as described in U.S. Pat. Nos. 7,122,295, 6,773,859, 5,279,697, 5,175,072 and 3,264,103, in published U.S. patent publication Nos. U.S. 2006/0124009 and U.S. 2010/0119978, and in WO 01/88615, WO 01/18604, and EP 1239329, the teachings of each of which are incorporated herein by reference in their entirety. These processes allow for the elimination of development solvents and the lengthy plate drying times needed to remove the solvent. The speed and efficiency of the process allow for use of the process in the manufacture of flexographic plates for printing newspapers and other publications where quick turnaround times and high productivity are important.

The composition of the photopolymer is such that there exists a substantial difference in the behavior of the cured and uncured polymer when subjected to heat. It is precisely this difference that allows the creation of an image in the cured photopolymer when heated. The uncured photopolymer (i.e., the portions of the photopolymer layer not contacted with actinic radiation) melts or substantially softens while the cured photopolymer remains solid and intact at the temperature chosen for thermal processing. Thus the difference in behavior allows the uncured photopolymer to be selectively removed, thereby creating an image.

The printing element is heated to a temperature sufficient to effect melting or softening by conduction, convection or other heating method as is known in the art. For example, the printing element may be heated to a temperature of at least about 70° C., more typically between about 120 to about 200° C. The exact temperature will depend upon the properties of the particular photopolymer being used. However, two primary factors are generally considered in determining the development temperature:

1) The development temperature is preferably set between the melting or softening temperature of the uncured photopolymer on the low end and the melting or softening temperature of the cured photopolymer on the upper end to allow for selective removal of the photopolymer, thereby creating the image; and

2) The higher the development temperature, the quicker the process time will be. Thus, while the development temperature should not be so high as to degrade the cured photopolymer, the temperature should be sufficient to melt or substantially soften the uncured photopolymer, thereby allowing it to be removed.

Once the printing element has been heated to the temperature sufficient to effect melting and/or softening of the uncured photopolymer, the uncured photopolymer can be removed. The heated printing element is contacted with a material that will absorb or otherwise remove the softened or melted uncured photopolymer. This removal process is generally referred to as “blotting” and is typically accomplished using an absorbent web of material. Either woven or non-woven material can be used and the material can be polymer based or paper, so long as the material is capable of withstanding the operating temperatures involved. Blotting is accomplished using one or more rollers to bring the blotting material and the heated printing element into contact.

The uncured photopolymer layer is heated by conduction, convection, or other heating method to a temperature sufficient to effect melting. By maintaining more or less intimate contact of the absorbent sheet material with the photocurable layer, a transfer of the uncured photopolymer from the photopolymer layer to the absorbent sheet material takes place. While still in the heated condition, the absorbent sheet material is separated from the cured photopolymer layer in contact with the support layer to reveal the relief structure. After cooling, the resulting flexographic printing plate can be mounted on a printing plate cylinder.

Upon completion of the development step, the printing plate element is optionally, but preferably, post-exposed to further actinic radiation and/or detacked. The printing element is then cooled and is ready for use.

A typical apparatus for thermally development (also known as thermal processing) comprises:

a) means for supporting the flexographic printing element;

b) heating means for softening or melting non-crosslinked photopolymer on the imaged and exposed surface of the flexographic printing element;

c) at least one roll that is capable of bringing a blotting material into contact with the surface of the flexographic printing element to remove the softened or melted non-crosslinked photopolymer on the surface of the flexographic printing element; and

d) means for maintaining contact between the at least one roll and the surface of the flexographic printing element.

U.S. Pat. Pub. No. 2010/0119978 to Vest and U.S. Pat. Pub. No. 2006/0124009 to Markhart, the subject matter of each of which is herein incorporated by reference in its entirety describe thermal development apparatuses in which the printing element is heated to a temperature sufficient to selectively melt or soften the uncured portions of the at least one layer of photopolymer such that the softened or melted uncured photopolymer is removable from the printing element by contacting the heated printing element with a blotting material.

### SUMMARY OF THE INVENTION

One problem that can arise in thermal processing is that the blotting material may not carry away all of the uncured photopolymer and thus buildup of uncured photopolymer can occur on the surface of the hot roll, diminishing the cleaning capabilities of the hot roll and leading to downtime in the process while the thermal processor is taken off-line for cleaning.

More recently, U.S. Pat. Pub. No. 2015/0048557 to Gotsick, the subject matter of which is herein incorporated by reference in its entirety, describes preventing the buildup of uncured photopolymer on the surface of the hot roll by using a scraping means which preferably comprises a doctor blade may be arranged adjacent to the hot roll to remove non-crosslinked photopolymer remaining on the surface of the hot roll.

However, the inventors of the present invention have determined that other improvements to the thermal development processor for removing non-crosslinked photopolymer remaining on the surface of the hot roll may also provide a good result.

It is an object of the present invention to provide an improved thermal development apparatus.

It is another object of the present invention to provide an improved thermal development apparatus having an improved cleaning mechanism for preventing buildup of uncured photopolymer material on a surface of the hot roll.

It is still another object of the present invention to provide a cleaning mechanism that does not require that the thermal development apparatus be taken offline.

To that end, in one embodiment, the present invention relates generally to an apparatus for thermally processing a relief image printing element, wherein the relief image printing element comprises at least one photopolymer layer, and wherein the relief image printing element is selectively exposed to actinic radiation to crosslink portions of the at least one photopolymer layer, while portions of the at least one photopolymer layer are not exposed to actinic radiation and are not crosslinked, the apparatus, comprising:
a) means for supporting the relief image printing element;
b) heating means for melting or softening non-crosslinked portions of the at least one photopolymer layer;
c) at least one rotatable roll that is capable of bringing a blotting material into contact with the at least one photopolymer layer to remove the melted or softened non-crosslinked portions of the at least one photopolymer layer, wherein a nip is formed between the means for supporting the relief image printing element and the at least one rotatable roll, wherein as the at least one rotatable roll rotates against the relief image printing element, melted or softened non-crosslinked portions of the at least one photopolymer layer are transferred from the relief image printing element to the blotting material;
d) a rotatable cleaning roll arranged adjacent to the at least one rotatable roll for removing non-crosslinked photopolymer remaining on a surface of the at least one rotatable roll after step c).

### BRIEF DESCRIPTION OF THE DRAWINGS

For a fuller understanding of the invention, reference is had to the following description taken in connection with the accompanying figures, in which:

FIG. 1 depicts an apparatus for thermally processing a relief image printing element in accordance with one embodiment of the present invention.

FIG. 2 depicts an apparatus for thermally processing a relief image printing element in accordance with another embodiment of the present invention.

Also, while not all elements may be labeled in each figure, all elements with the same reference number indicate similar or identical parts.

### DETAILED DESCRIPTION OF THE PREFERRED EMBODIMENTS

In one embodiment, the present invention relates generally to an apparatus for thermally processing a relief image printing element, wherein the relief image printing element comprises at least one photopolymer layer, and wherein the relief image printing element is selectively exposed to actinic radiation to crosslink portions of the at least one photopolymer layer, while portions of the at least one photopolymer layer are not exposed to actinic radiation, and are not crosslinked, the apparatus comprising:
a) means for supporting the relief image printing element;
b) heating means for melting or softening non-crosslinked portions of the at least one photopolymer layer;
c) at least one rotatable roll that is capable of bringing a blotting material into contact with the at least one photopolymer layer to remove the melted or softened non-crosslinked portions of the at least one photopolymer layer, wherein a nip is formed between the means for supporting the relief image printing element and the at least one rotatable roll, wherein as the at least one rotatable roll rotates against the relief image printing element, melted or softened non-crosslinked portions of the at least one photopolymer layer are transferred from the printing element to the blotting material;
d) a rotatable cleaning roll arranged adjacent to the at least one rotatable roll, for removing non-crosslinked photopolymer remaining on a surface of the at least one rotatable roll after step c).

As described herein, the rotatable cleaning roll is used to remove residual photopolymer remaining on a surface of the at least one rotatable roll after thermal processing.

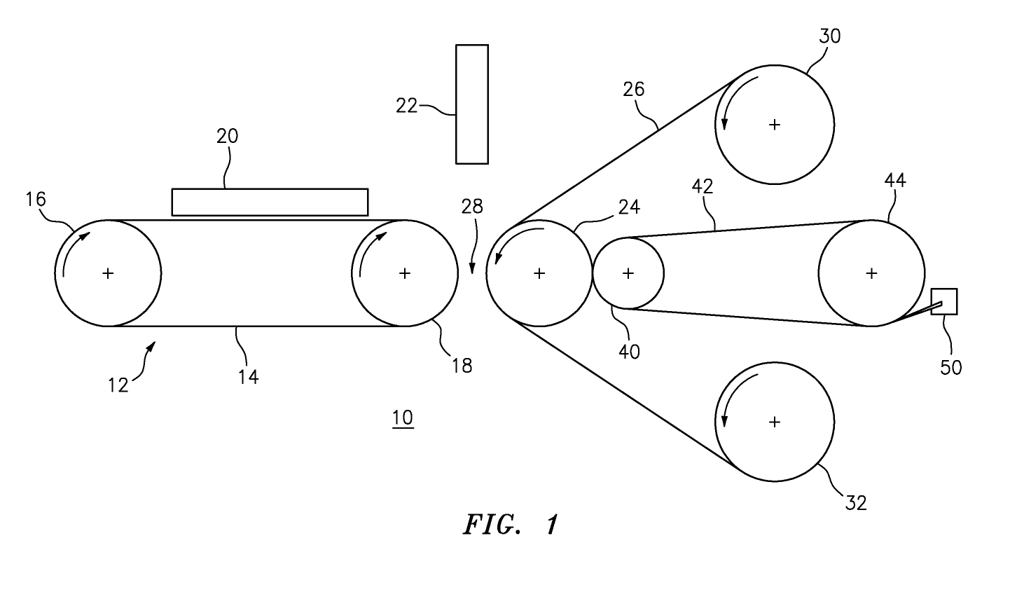

The rotatable cleaning roll is situated at a point after the used blotting material detaches from the at least one rotatable roll, but before the point where the clean non-woven blotter initially contacts the at least one rotatable roll. Thus, in one embodiment, and as seen in FIG. 1, the rotatable cleaning roll 40 is situated at a point that is approximately 180° from the nip 28 formed between the means for supporting the relief image printing element 20 and the at least one rotatable roll 24. Thus, the rotatable cleaning roll 40 is situated at a point that is approximately directly opposite that of the nip 28.

The rotatable cleaning roll 40 rotates against a surface of the at least one rotatable roll 24 to remove any non-crosslinked photopolymer remaining on the surface of the at least one rotatable roll 24 after the blotting material 26 has removed substantially all of the non-crosslinked photopolymer from the surface of the printing element 20.

The rotatable cleaning roll 40 rotates at a speed that is sufficient to remove substantially all of the residual photopolymer remaining on the at least one rotatable roll 24. By substantially what is meant is that there is no visible residual photopolymer remaining on the surface of the at least one rotatable roll.

In one embodiment, the at least one rotatable roll 24 rotates at a first speed and the rotatable cleaning roll 40 rotates at a second slower speed. In another embodiment, the at least one rotatable roll 24 and the rotatable cleaning roll 40 rotate at substantially the same speed.

As also seen in FIG. 1, the rotatable cleaning roll 40 is substantially smaller than the at least one rotatable roll 24 so that the rotatable cleaning roll 40 does not interfere in any way with the operation of the at least one rotatable roll 24 in removing non-crosslinked photopolymer from the surface of the relief image printing element 20. Thus, in one embodiment the rotatable cleaning roll 40 has a diameter that is less than about 75% of the diameter of the at least one rotatable roll 24, and more preferable has a diameter that is less than about 50% of the diameter of the at least one rotatable roll 24.

In one embodiment, the rotatable cleaning roll 40 comprises a cleaning belt 42. The cleaning belt 42 is a continuous belt that is supported by the rotatable cleaning roll 40 and a second larger roll 44 spaced apart from the rotatable cleaning roll 24 to maintain tension on the cleaning belt 42 wrapped around the rotatable cleaning roll 40 and the second roll 44. Thus, in this embodiment the cleaning belt itself picks up the residual non-crosslinked photopolymer remaining on the at least one rotatable roll 24. In addition, if desired, the cleaning belt 42 may further comprise a scraping means 50 positioned adjacent to the second larger roll 44 to scrape collected photopolymer from the surface of the cleaning belt 42. The scraping means 50 can be a doctor blade or another similar device shaped to fit against the surface of the second larger roll 44. The scraping means 50 may be coupled to a blade holder so that the scraping means 50 can be adjusted and/or replaced as needed.

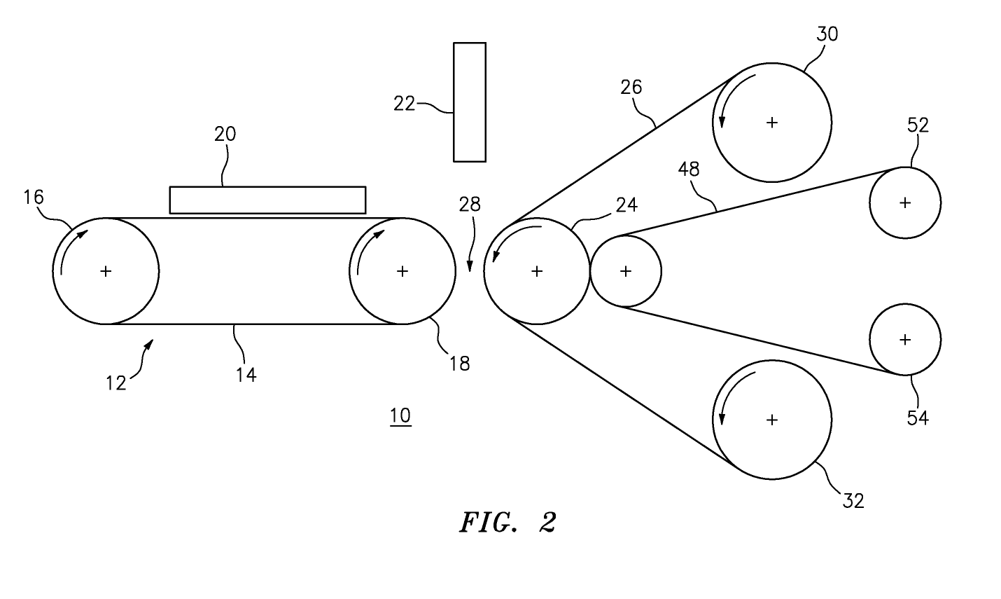

In another embodiment, the rotatable cleaning roll 40 comprises a blotting material 48 that is brought into contact with a surface of the at least one rotatable roll 40 at a point substantially opposite the nip 28 so that the blotting material 48 on the rotatable cleaning roll 40 can remove residual non-crosslinked photopolymer remaining on the surface of the at least one rotatable roll 24. In this embodiment, the blotting material 48 of the rotatable cleaning roll 40 is separate from the blotting material 26 of the at least one rotatable roll 24 and the two blotting materials each have a separate feed roll and take up roll as seen in FIG. 2. Thus, the primary blotting material 26 for removing non-crosslinked photopolymer from the surface of the relief image printing element 20 is supplied from a supply roller 30 and is rewound onto take-up roller 32, while the secondary blotting material 48 for removing residual non-crosslinked photopolymer is supplied from secondary supply roller 52 and is rewound onto secondary take-up roller 54. In addition, while the particular blotting material used for both the at least one rotatable roll 24 and the rotatable cleaning roll 40 may comprise the same material, the feed sources for each source of blotting material are different.

One advantage of the cleaning roll described herein is that the cleaning roll functions continuously during operation of the thermal processor, thereby reducing the amount of time that that the photopolymer residue remains on the hot surface of the at least one rotatable roll. This reduces the tendency of the photopolymer residue to degrade and become intractable to cleaning.

The thermal processor 10 of the invention comprising a means for supporting the relief image printing element 20. As depicted in FIG. 1, one means for supporting the relief image printing element 20 comprises a conveyor 12 comprising a continuous loop 14 arranged around a plurality of rolls 16 and 18. Optionally, one or more additional rollers (not shown) may be used to provide additional support to the conveyor 12 to prevent the continuous loop 14 from sagging from the weight of the relief image printing element 20. In one embodiment, the continuous loop 14 comprises wire mesh. The relief image printing element 20 may be held on the conveyor 12 by various means, including a clamp, vacuum or friction. In an alternate embodiment, the relief image printing element may be in the form of a continuous in-the-round (CITR) photopolymer sleeve and the means for supporting the CITR photopolymer sleeve comprising a printing cylinder. Other means for supporting the relief image printing element 20 would also be known to those skilled in the art.

The heating means for melting or softening non-crosslinked photopolymer may comprise a supplemental heater 22 arranged in a preheating zone prior to and/or adjacent to the at least one rotatable roll 24 to improve the efficiency of the softening/melting of the non-crosslinked photopolymer and to further soften and liquefy portions of the at least one layer of photopolymer material. Although various types of heaters may be used, preferably the supplemental heater is an infrared heater.

In addition, the at least one rotatable roll 24 is preferably heated to and maintained at a temperature of between about 120 and about 200° C. while the relief image printing element 20 is in contact with the at least one rotatable roll 24 through the blotting material 26. This allows the at least one rotatable roll 24 to melt and/or soften the non-crosslinked photopolymer and allows for the melted or softened photopolymer to be removed from the surface of the relief image printing element 20.

The at least one rotatable roll 24 is capable of bringing a blotting material 26 into contact with the at least one photopolymer layer of the relief image printing element 20 to remove the melted or softened non-crosslinked portions of the at least one photopolymer layer, wherein a nip 28 is formed between the means for supporting the relief image printing element 20 and the at least one rotatable roll 24, wherein as the at least one rotatable roll 24 rotates against the relief image printing element 20, melted or softened non-crosslinked portions of the at least one photopolymer layer are transferred from the printing element 20 to the blotting material 26.

The blotting material 26 is supplied to the at least one rotatable roll 24 from a supply roll 30 of the blotting material 26, wherein the blotting material 26 is fed from the supply roll 30 and around an outer surface of the at least one rotatable roll 24, wherein the blotting material 26 initially contacts the at least one rotatable roll 24 at a point prior to the nip 28 and separates from the at least one rotatable roll 24 at a point after the nip 28. The blotting material 26 is looped under and around at least the portion of the at least one rotatable roll 24 that contacts the imaged surface of the relief image printing element 20. Fresh blotting material 26 is continuously supplied to the surface of the at least one rotatable roll 24 from the supply roll 30 of the web of blotting material 26.

The apparatus described herein also comprises a take-up roll 32, wherein the blotting material 26 containing melted or softened non-crosslinked portions of the at least one photopolymer layer is rewound for disposal. The take-up roll 32 may be independently belt driven by a motor (not shown), such as a variable speed motor. The take-up roll 32 collects the web of blotting material 26 after it has contacted the relief image printing element 20 and removed portions of the photopolymer layer that were liquefied or softened. An auto-slicing device (not shown), may be used to change over the supply roll 30 of blotting material 26 to a fresh roll of blotting material 26.

The blotting materials 26 and 48 may be selected from the group consisting of screen mesh, woven fabric, non-woven fabric, paper and other similar materials that can withstand the operating temperatures of the thermal processor and absorb and remove non-crosslinked photopolymer. Either woven or non-woven fabric is used and the fabric can be polymer based or paper, so long as the fabric can withstand the operating temperatures involved. The selection of the blotting material depends in part upon the thickness of the photosensitive printing element to be processed, the melting temperature of the blotting material, and the heat transfer characteristics of both the photosensitive printing element and the blotting material. In one embodiment, the blotting material 26 is a non-woven blotting material, such as a non-woven fabric.

The cleaning belt 42 may comprise a material that is suitable for taking up and removing non-crosslinked photopolymer remaining on the surface of the at least one rotatable roll 24. The material of the cleaning belt must be sufficient tough and durable for long term use at the temperature of the thermal processor and be flexible to be wrapped around the rotatable cleaning roll 40. For example, the cleaning belt may comprise polyurethane resins, ethylene-propylene-diene rubbers, silicone rubbers, among others.

The apparatus described herein also preferably comprises a means for maintaining contact between the at least one roll 24 and the relief image printing element 20. The means for maintaining contact may comprise an air cylinder or a hydraulic cylinder that acts to force the at least one roll 24 against the imaged surface of the relief image printing element 20. Other means for maintaining contact between the at least one roll 24 and the relief image printing element 20 would also be known to those skilled in the art.

The present invention also relates generally to a method of thermally processing a relief image printing element using the apparatus described herein. As described above, the relief image printing element comprises a backing layer and at least one photopolymer layer disposed on the backing layer, wherein the relief image printing element is selectively exposed to actinic radiation to crosslink portions of the at least one photopolymer layer, wherein portions of the at least one photopolymer layer are not exposed to actinic radiation and are not crosslinked. The method generally comprises the steps of:
a) melting or softening non-crosslinked portions of the at least one photopolymer layer;
b) causing contact between the surface of the relief image printing element and a blotting material arranged on a portion of the at least one rotatable roll, wherein when the at least one rotatable roll rotates, the blotting material contacts at least a portion of a surface of the at least one photopolymer layer and melted or softened non-crosslinked portions of the at least one photopolymer layer are transferred to the blotting material; and
c) causing contact between the at least one rotatable roll and a rotatable cleaning roll after the blotting material contacts the at least the portion of the surface of the at least one photopolymer layer.

As described herein the step of causing contact between the at least one rotatable roll 24 and a rotatable cleaning roll 40 after the blotting material 26 contacts the at least the portion of the surface of the at least one photopolymer layer comprises positioning the rotatable cleaning roll 40 adjacent to the at least one rotatable roll 24 at a point that is approximately opposite the nip 28 formed between the means for supporting the relief image printing element 20 and the at least one rotatable roll 24. Thus, when the at least one rotatable roll 24 rotates against at least a portion of the relief image printing element 20 and non-crosslinked photopolymer is removed from the surface of the at least the portion of the relief image printing element 20 by the blotting material 26, any residual non-crosslinked photopolymer remaining on the surface of the at least one rotatable roll after the blotting step can be removed by the at least one rotatable cleaning roll 40.

The thermal nip 28 is used to transfer non-crosslinked photopolymer from the imaged relief image printing element 20 to the surface of at least one rotatable roll 24 which is preferably heated to a temperature of between about 120 and about 200° C. Thereafter, the at least one rotatable roll with the cleaning belt 42 or the secondary blotting material 48 positioned thereon, is used to remove the residual non-crosslinked photopolymer.

The use of the at least one rotatable cleaning roll 40 described herein improves the function of the thermal processing device; while at the same time drastically reduces the complexity of the thermal processing device.

1. An apparatus for thermally processing a relief image printing element, wherein the relief image printing element comprises at least one photopolymer layer, and wherein the relief image printing element is selectively exposed to actinic radiation to crosslink portions of the at least one photopolymer layer, while portions of the at least one photopolymer layer are not exposed to actinic radiation, and are not crosslinked, the apparatus comprising:
a) means for supporting the relief image printing element;
b) heating means for melting or softening non-crosslinked portions of the at least one photopolymer layer;
c) at least one rotatable roll that is capable of bringing a moving web of blotting material into contact with the at least one photopolymer layer to remove the melted or softened non-crosslinked portions of the at least one photopolymer layer, wherein a nip is formed between the means for supporting the relief image printing element and the at least one rotatable roll, wherein as the at least one rotatable roll rotates against the relief image printing element, melted or softened non-crosslinked portions of the at least one photopolymer layer are transferred from the printing element to the moving web of blotting material;
d) a rotatable cleaning roll arranged adjacent to the at least one rotatable roll, for removing non-crosslinked photopolymer remaining on a surface of the at least one rotatable roll after step c), wherein the rotatable cleaning roll comprises a cleaning belt, wherein the cleaning belt is supported by the rotatable cleaning roll and a second roll spaced apart from the rotatable cleaning roll;
wherein the rotatable cleaning belt rotates against the surface of the at least one rotatable roll after the moving web of blotting material has removed substantially all of the non-crosslinked photopolymer remaining on the surface of the at least one roll to transfer non-crosslinked photopolymer from the surface of the at least one rotatable roll to a surface of the cleaning belt.

2. (canceled)

3. The apparatus according to claim 1, wherein the rotatable cleaning roll rotates at a speed that is sufficient to remove substantially all of the residual photopolymer remaining on the at least one rotatable roll.

4. The apparatus according to claim 3, wherein the rotatable cleaning roll rotates at a speed that is slower than the rotational speed of the at least one rotatable roll.

5. The apparatus according to claim 3, wherein the rotatable cleaning roll rotates at substantially the same speed as the at least one rotatable roll.

6. The apparatus according to claim 1, wherein the rotatable cleaning roller is substantially smaller than the at least one rotatable roll.

7. The apparatus according to claim 6, wherein the rotatable cleaning roller has a diameter that is less than about 75% of the diameter of the at least one rotatable roll.

8. The apparatus according to claim 7, wherein the rotatable cleaning roller has a diameter that is less than about 50% of the diameter of the at least one rotatable roll.

9. (canceled)

10. The apparatus according to claim 1, wherein the cleaning belt is a continuous belt.

11. The apparatus according to claim 1, wherein the cleaning belt comprises a material selected from the group consisting of polyurethane resins, ethylene-propylene-diene rubbers, silicone rubbers and combinations of one or more of the foregoing.

12. The apparatus according to claim 1, comprising a scraping means positioned adjacent to the second roll, when the scraping means scrapes collected residual photopolymer from the surface of the cleaning belt.

13. (canceled)

14. A method of thermally processing a relief image printing element, wherein the relief image printing element comprises a backing layer and at least one photopolymer layer disposed on the backing layer, wherein the relief image printing element is selectively exposed to actinic radiation to crosslink portions of the at least one photopolymer layer, wherein portions of the at least one photopolymer layer are not exposed to actinic radiation and are not crosslinked, the method comprising the steps of:
a) melting or softening non-crosslinked portions of the at least one photopolymer layer;
b) causing contact between the surface of the relief image printing element and a moving web of blotting material arranged on a portion of the at least one rotatable roll, wherein when the at least one rotatable roll rotates, the moving web of blotting material contacts at least a portion of a surface of the at least one photopolymer layer and melted or softened non-crosslinked portions of the at least one photopolymer layer are transferred to the moving web of blotting material; and
c) causing contact between the at least one rotatable roll and a rotatable cleaning roll after the moving web of blotting material contacts the at least the portion of the surface of the at least one photopolymer layer, wherein the rotatable cleaning roll comprises a cleaning belt, wherein the cleaning belt is supported by the rotatable cleaning roll and a second roll spaced apart from the rotatable cleaning roll;
wherein the cleaning belt rotates against the surface of the at least one rotatable roll after the moving web of blotting material has removed substantially all of the non-crosslinked photopolymer remaining on the surface of the at least one roll to transfer non-crosslinked photopolymer from the surface of the at least one rotatable roll to a surface of the cleaning belt.

15. (canceled)

16. (canceled)

17. The method according to claim 14, wherein the cleaning belt is a continuous belt.

18. The method according to claim 14, further comprising the step of scraping collected residual photopolymer from the surface of the cleaning belt.

19. (canceled)
